(19) United States
(12) Patent Application Publication
(10) Pub. No.: US 2002/0124704 A1
(43) Pub. Date: Sep. 12, 2002

(54) Roll feed bottom sheet inserter

(76) Inventor: Curtis A. Roth, Post Falls, ID (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 10/143,328

(22) Filed: May 9, 2002

Related U.S. Application Data
(63) Continuation-in-part of application No. 10/087,727, filed on Feb. 26, 2002.
Application No. 10/087,727 is a continuation-in-part of application No. 09/632,828, filed on Aug. 7, 2000.

(51) Int. Cl. B23D 25/00

(52) U.S. Cl. 83/436.5; 83/436.55; 83/436.6; 226/181; 226/189

(57) ABSTRACT

A roll feed bottom sheet inserter is described in which a conveyor on a conveyor frame includes a working flight defining a load support surface and a forward load path leading to a bottom sheet insertion station. A bottom sheet roll support mounting a bottom sheet roll is located adjacent to and extends alongside the working flight to feed sheet material from the roll to the conveyor. A training surface is oriented to receive material from the roll and to angularly deflect the material to a feed path that converges with the load support surface from under the working flight. A bottom sheet feeder operates to receive material from the training surface and to feed the material through the insertion station and into the load path so the bottom sheet material may be positioned on the conveyor between the load and support surface.

### CROSS REFERENCE TO RELATED APPLICATION

This application is a Continuation-in-Part of prior U.S. Pat. application Ser. No. 10/087,727, filed Feb. 26, 2002 which is a Continuation-in-Part of U.S. patent application Ser. No. 09/632,828, which was filed Aug. 7, 2000 now abandoned and both of which are incorporated by reference herein.

### TECHNICAL FIELD

The present invention relates to apparatus and processes for placing a bottom sheet below a load and more particularly to feeding the bottom sheet from a roll.

### BACKGROUND OF THE INVENTION

It is often desirable to place a sheet of material such as corrugated board under a load to protect the load against damage from lifting, transport or other handling operations.

Loads may either be too heavy to lift for placement of a bottom sheet, or it may be undesirable to interrupt progress of loads being transported for placement of bottom sheets.

Further, some loads such as stacked materials may become disheveled if lifted or otherwise shifted to allow access for placement of a bottom sheet. The stacked material in the load may shift or topple if lifted from an end or a side. Further, full access to the area under the load may not be permitted unless the entire load is lifted to provide clearance for placement of the bottom sheet or sheets.

Of course, loads may be formed on bottom sheets that are set in position before the load is formed. However, the sheets are often not of substantial weight and can easily shift position before the load is received. Further, the bottom sheet may interfere or disrupt a load accumulation process, especially in situations where the load is progressively formed in a stack.

Bottom sheets are typically supplied as individual sheets that are placed under loads. However the sheet material that may be selected for use as bottom sheets may also be supplied in rolls.

It has been considered that roll fed bottom sheets would require significant alteration, either of the load conveying equipment or of the adjacent facility in order to fit the bottom sheet roll beneath the existing conveying surface. Still, an advantage of roll fed bottom sheets is that the bottom sheet length may be limited only by the length of sheet material on the roll. Thus a single roll of sheet material could be used to feed bottom sheets under loads of widely varied dimensions.

It may be seen from the foregoing, that there is a need for a roll fed bottom sheet inserter that may be assembled with or retrofitted to existing conveying equipment without requiring significant alteration to the adjacent facility or to the existing conveying equipment.

### BRIEF DESCRIPTION OF THE DRAWINGS

Preferred embodiments of the invention are described below with reference to the following accompanying drawings.

FIG. 1 is a schematic perspective view indicating the flow path of rolled bottom sheet material from a roll alongside a conveyor (shown in phantom lines) to a bottom sheet insertion station along the conveyor;

FIG. 2 is a schematic top view also showing the feed path from one side of the conveyor to a position under the conveyor, and from there to the bottom sheet insertion station; and further showing a load resting on a previously placed sheet;

FIG. 3 is a perspective view of a preferred combination conveyor and bottom sheet roll feed;

FIG. 4 is a view similar to FIG. 3, only showing the components in a bottom sheet roll changing mode at a roll exchange station;

FIG. 5 is a perspective view of a preferred roll sheet inserter sub-combination, independent of the conveyor;

FIG. 6 is a plan view of a preferred assembly with the bottom sheet frame moved away from the conveyor to the roll exchange station;

FIG. 7 is a view similar to FIG. 6 only showing the load on the conveyor working flight and the roll feed in operative position alongside the conveyor;

FIG. 8 is an enlarged section view taken substantially along the reference line 8-8 in FIG. 7; and

FIG. 9 is a fragmented perspective view of the elements shown in FIG. 8.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

Before describing details of preferred elements and steps, general aspects of the invention will be described.

One preferred aspect includes a roll feed bottom sheet inserter 10 that includes a conveyor frame 12. A conveyor 14 on the conveyor frame 12 includes a working flight 16 that defines a load support surface 18 and a forward path of travel P for the load. The conveyor 14 is operable to move a load L along the path P to a bottom sheet insertion station 20. A bottom sheet roll support 22 is configured to rotatably mount a bottom sheet roll R about a roll axis X that is located adjacent to and extending alongside the working flight 16 to feed sheet material S from the roll R and toward the conveyor 14. A training surface 24 is positioned adjacent the roll support 22, and is oriented to receive bottom sheet material S from the bottom sheet material roll R and to angularly deflect the bottom sheet material S to a bottom sheet feed path F that converges with the load support surface 18 from under the working flight 16. A bottom sheet feeder 26 is located adjacent the bottom sheet insertion station 20 and is operable to receive the bottom sheet material S from the training surface 24 and feed the bottom sheet material S through the bottom sheet material insertion station 20 and into the forward P path of the load L such that the bottom sheet material S may be positioned on the conveyor between the load support surface 18 and the load L.

In another aspect, the roll feed bottom sheet inserter 10 is provided for placing bottom sheet material S under a load L moving along and supported by a working flight 16 of a conveyor 14. A bottom sheet roll support 22 is configured to be positioned to a side of the conveyor 14 to mount a bottom sheet roll R for rotation about a roll axis X adjacent to the working flight 16, and to feed sheet material S from the roll R and toward the conveyor 14. A training surface 24 is disposed adjacent the roll support 22 and is oriented to receive bottom sheet material S from the bottom sheet roll R and to angularly deflect the bottom sheet material S along a bottom sheet feed path F. A bottom sheet feeder 26 is situated adjacent to the bottom sheet insertion station 20 and is operable to receive the bottom sheet material S from the training surface 24. The bottom sheet feeder 26 is also adapted to feed the bottom sheet material S into the forward path P of the load L on the conveyor 14 such that the bottom sheet material S is received under the load L.

A further aspect includes a process for inserting a bottom sheet from a roll R of bottom sheet material S into position under a load L on a conveyor and over a top support surface 18 of the conveyor which defines a forward path of travel P for the load L, and mounting a bottom sheet roll R for rotation about a roll axis X located along side the conveyor support surface 18 and forward path of travel P. Bottom sheet material S is fed from the roll R along an initial feed path I toward and under the conveyor support surface 18. The process further includes training the bottom sheet materials over a mandrel 25 to deflect the bottom sheet material S angularly under the conveyor support surface 18 and into a bottom sheet feed path F that converges with the forward path P and with a bottom sheet insertion station 20 located along the conveyor support surface 18. The process further includes feeding the bottom sheet material S through the bottom sheet insertion station S and moving the load L in the forward path P to intersect with the bottom sheet material S at the bottom sheet insertion station 20, and moving the bottom sheet material S and load L together in the forward path P with the bottom sheet materials feeding under the load L and onto the conveyor support surface 18.

Another aspect involves a process for adapting a load moving conveyor 14 to insert bottom sheet material S from a roll R of bottom sheet material into position under a working flight 16 of the conveyor that defines a forward path of travel P for the load L. The process includes providing a bottom sheet frame 28 and mounting a bottom sheet roll R to the frame 28 for rotation about a roll axis X. The process also includes feeding bottom sheet material S from the roll R along an initial feed path I from the roll R to a mandrel 25, and training the bottom sheet material over the mandrel 25 to deflect the material angularly from the initial feed path I and into a bottom sheet feed path F. The process further includes gripping the bottom sheet materials between powered nip rolls 30 that are operable to pull the bottom sheet materials from the roll R and over the mandrel 25, and to feed the bottom sheet material S along a bottom sheet material feed path F. A further step includes providing a bottom sheet insertion station 20 along the conveyor 14; and positioning the mandrel 25 and powered nip rolls 30 beneath the conveyor support surface 18 such that the bottom sheet material feed path F converges with the bottom sheet insertion station 20 along the conveyor support surface 18. Another step includes driving the nip rolls 30 to feed the bottom sheet materials through the bottom sheet insertion station 20.

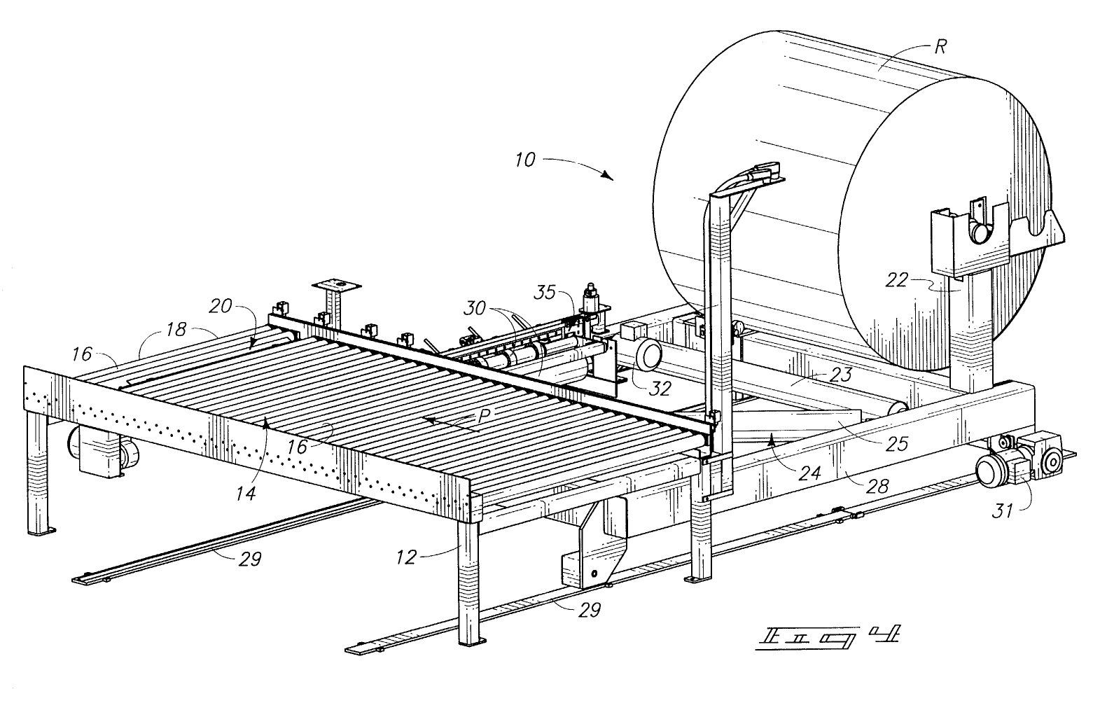

In referring to the drawings in more detail, and especially to FIG. 3, the conveyor 14 is shown mounted by the conveyor frame 12 at an elevation above a support surface such as a floor. The working flight 16 and load support surface 18 defined by the working flight are held at a prescribed elevation by the support frame 12. In the illustrated example, the working flight is made up of a multiplicity of conveyor rollers that are powered to move loads such as stacked corrugated materials in the forward path P. The top surfaces of the rolls define the load support surface 18. It is noted that other forms of conveyor could be used including belt-type conveyors and that the roller conveyor as illustrated is shown by way of example.

The conveyor 14 is interrupted along the working flight 16 by a space which at least partially defines the bottom sheet insertion station 20. Thus, a portion of the conveyor working flight 16 and support surface 18 are situated upstream of the sheet insertion station 20 and a portion is situated downstream. Both sections of the conveyor are preferably powered to move the load in the forward path P.

It is pointed out that the illustrated conveyor shows both sections of the working flight 16 and load support surface 18 on opposite sides of the sheet insertion station 20 as being substantially horizontal and co-planar. However, it is possible that the conveyor load support surfaces be oriented at an angular plane or along a slight curvature depending upon a particular installation.

It is also noted that the conveyor 14 may be an existing conveyor that may be adapted for bottom sheet insertion by the bottom sheet inserter 10. It is also quite possible to provide both the conveyor and the bottom sheet inserter elements in combination for placement in an existing conveyor line. Thus, the inserter may be provided as a combination including the conveyor, or as a sub-combination to be retrofitted or mounted to an existing conveyor arrangement.

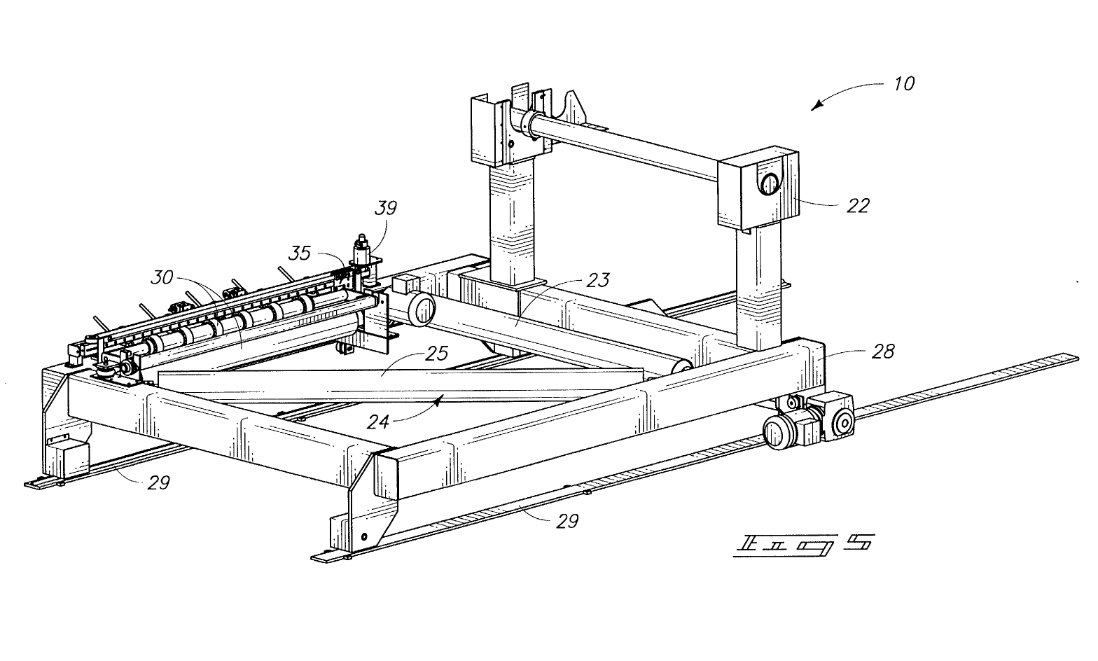

FIG. 3 illustrates the preferred inserter 10 in relation with the conveyor 14 such that the roll R is in position to feed a continuous supply of sheet material to the bottom sheet insertion station 20. In the FIG. 4 example, the roll R and associated components are shown separated from the conveyor and positioned at a roll exchange position whereby an empty roll may be exchanged for a full roll and the sheet material may be trained over the mandril 25 and attached to the nip rolls 30 before being moved back to the operative, FIG. 3 position.

In a preferred form, the bottom sheet frame 28 is track-mounted for movement along guides or track members 29. The tracks 29 run along the support surface from the spaced, roll exchange location to a position under the working flight 16. Appropriate wheels and a crawler drive mechanism 31 may be used to selectively move the frame 28 and attached elements along the tracks 29 between the two positions. Alternatively, the bottom sheet frame 28 and elements mounted thereto could be manually moved.

The bottom sheet frame 28 is made to include a low profile. This is done to facilitate insertion of the mandril 25, nip rolls 30 and associated elements under the working flight 16 without requiring significant, if any, modification of the existing facility. Further, in retrofit situations, little modification of the conveyor is required.

The roll support 22 is preferably comprised of two upright standards having upwardly open socket members for reception of the roll hub. FIG. 3 shows the top ends of the support 22 closed over the roll core, while FIG. 4 shows the top ends in an open condition facilitating mounting and dismounting of the roll or roll core.

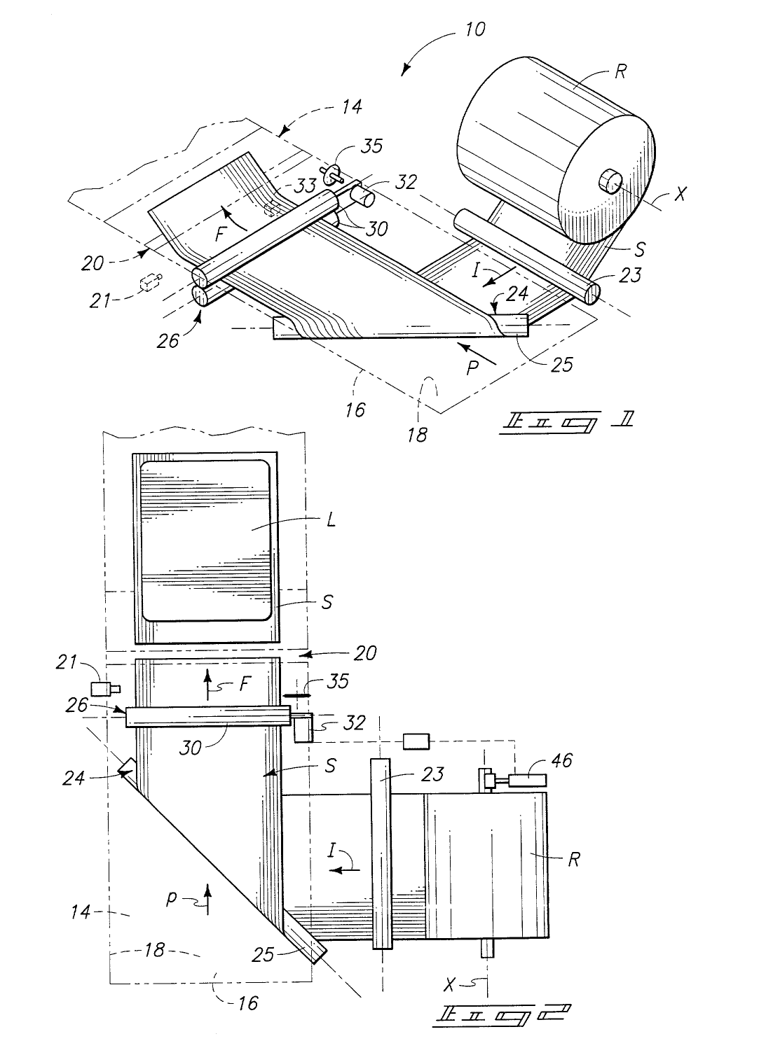

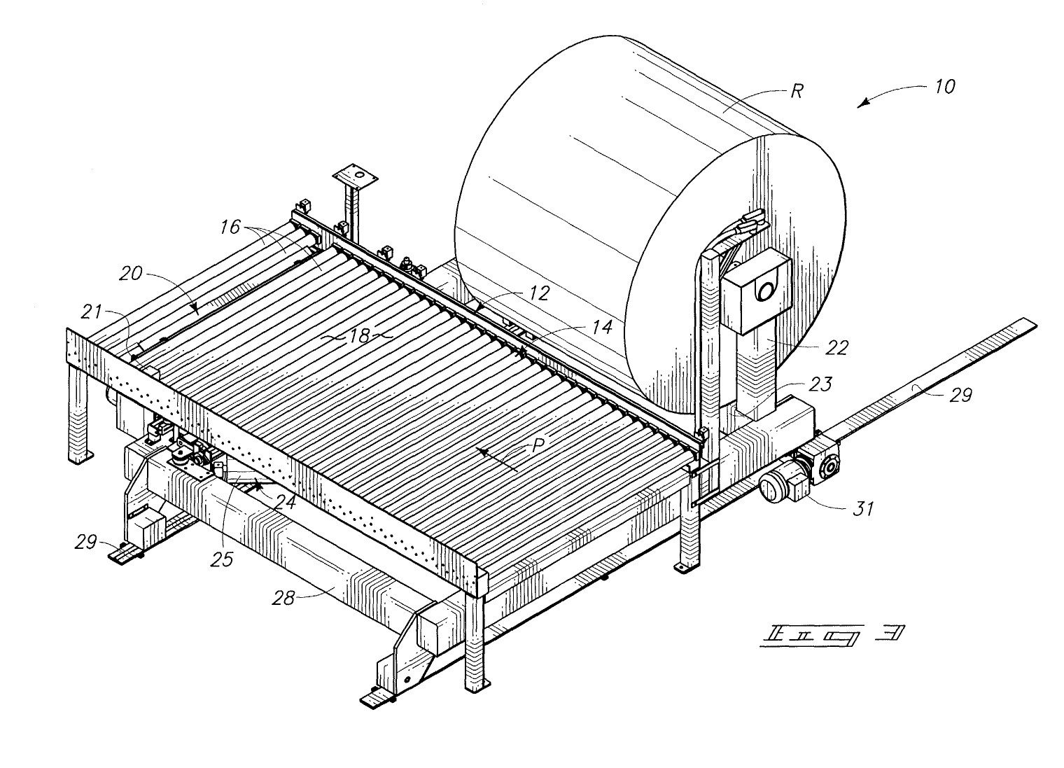

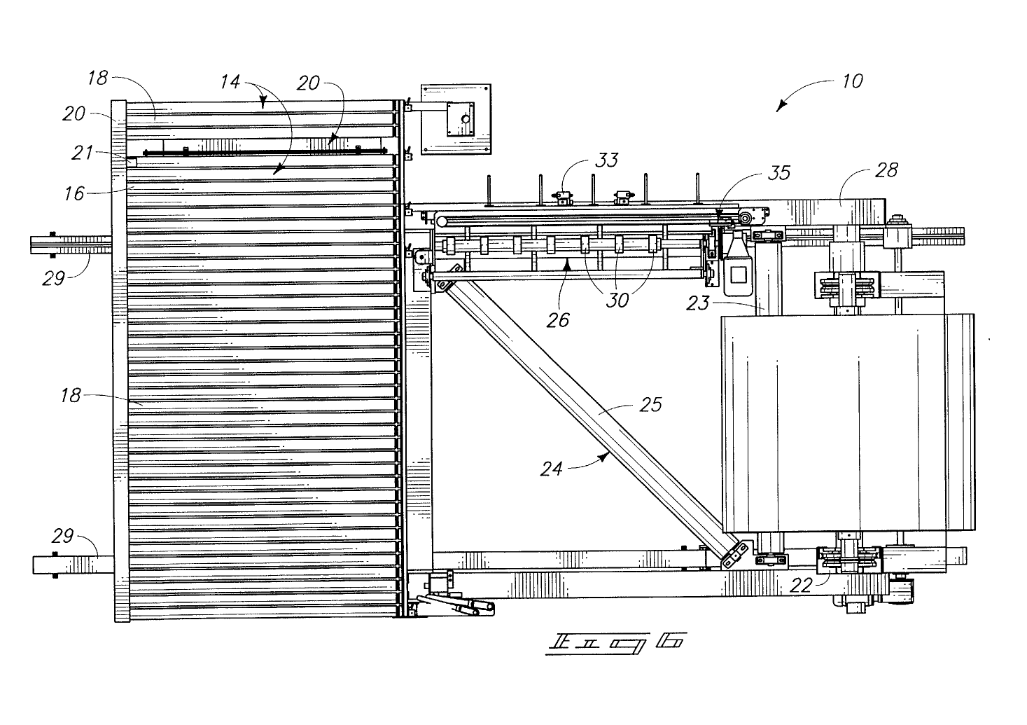

Sheet materials may be fed from the roll R on the support 22, past an idler roll 23 which is shown in schematic form in FIGS. 1 and 2 and more specifically in a preferred arrangement in FIGS. 4-6. The idler roll 23 is simply provided to initially position the roll sheet materials at a desired elevation and in a preferred horizontal feed plane along an initial feed path I (FIGS. 1 and 2) toward the training surface 24. The idler roll 23 may be freely rotatably mounted to the frame 28.

From the idler roll 23, the preferred direction of the sheet feed changes to the sheet feed path F by operation of the training surface 24. In preferred forms, the training surface 24 is provided in the form of the mandril 25 which is positioned at a selected angle in order to angularly deflect the bottom sheet material to the bottom sheet feed path F which is said to converge with the conveyor load support surface 18.

In the illustrated example, the mandril 25 is situated in an approximate 45° angle to the path P and longitudinal extent of the conveyor 14. Other angular relationships could be used so long as the resulting sheet feed path F ends up substantially coincidental with or parallel to the forward path P of a load L on the conveyor.

In preferred forms, the mandril 25 is provided in the form of a cylindrical roller that is held at least substantially stationary about the long mandril axis. It is preferred that the sheet material slide over the mandril surface as opposed to allowing the mandril 25 to rotate. By holding the mandril surface relatively stationary, there is little tendency for the sheet material to “walk” along the mandril surface in one direction or another.

The sheet material S is preferably fed from the roll R under the idler roll 23, under and over the mandril 25 and along the new directional path F toward the nip rollers 30. Sheet material is received between the nip rollers 30 which may be driven by appropriate controlled drive mechanism 32 to pull the sheet material over the mandril and from the roll R. To this end, the nip rolls may be formed of a high friction material.

The nip rolls are positioned along the frame 28 to be substantially parallel with the rolls of the conveyor or substantially perpendicular to the path P of loads moving along the conveyor. Further, the nip rolls are preferably positioned to be situated slightly upstream from and adjacent to the bottom sheet insertion station 20. Thus, bottom sheet material fed from the nip rolls 30 will move along the bottom sheet flow path F substantially in the same direction as the forward path P of a load moving along the conveyor 14.

It is preferable that the drive mechanism 32 for the nip rolls be set to move the sheet material along the path F at approximately the same rate of movement as the load L is moved along the conveyor 14. Such operational speed control will facilitate smooth transition of the bottom sheet materials under the load L as the load moves forwardly at substantially the same velocity.

In preferred forms, a cutter 35 is positioned along the frame 28 and is operable to cut successive lengths of the sheet material following placement under one or more loads L. Cutting operations may be initiated according to selected input from appropriate conventional control mechanisms on the conveyor, or by manual control using appropriate conventional switching mechanisms.

The preferred form of cutter 35 may include a substantially circular cutoff blade 36 (FIG. 9). The cutoff blade 36 may be selected from conventional forms of sharp rotary cutters and be rotatably mounted to a carriage 37 that is powered to move across the bottom sheet material. The cutter will cut the material as the carriage 37 is moved laterally across the path F of the bottom sheet material. The cutting action may occur in both directions across the path.

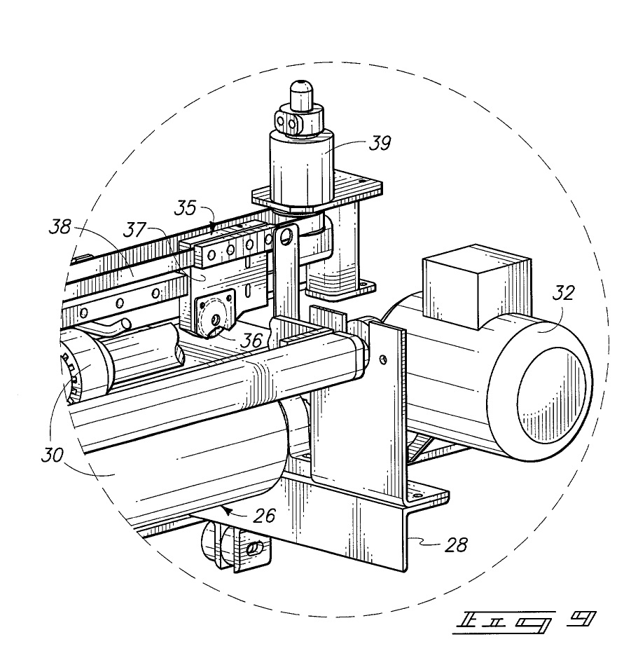

The carriage 37 is moved by provision of a drive belt and pulley assembly 38 (FIGS. 8, 9) mounted to the frame 28 on opposite sides of the bottom sheet flow path F. A drive motor 39 of appropriate form may be provided to move the belt and cutter carriage 37 in a reciprocating manner across the bottom sheet flow path F.

The knife blade 36 is mounted to the carriage 38 for movement across the bottom sheet material at a location downstream of the bottom sheet feeder 26 (nip rolls 30) with respect to the forward path of travel F. Further, the cutter location is preferably situated between the bottom sheet feeder 26 and the bottom sheet insertion station 20 (when the bottom sheet frame 28 and associated components are positioned in the operative position as indicated in FIGS. 1, 3 and 7).

Referring to FIG. 8, it may be seen that preferred forms of the feeding arrangement includes an upwardly angled guide 40. The guide 40 preferably is oriented to feed sheet materials received from between the nip rolls 30, upwardly through the bottom sheet insertion station 20. The guide 40 may be mounted to the conveyor frame 12 to project between successive conveyor rollers on opposite sides of the insertion station 20 and between side members of the conveyor frame 12. Upper guide finger arrangements 41, 42 may also be provided to keep the sheet material in position for insertion through the insertion station 20.

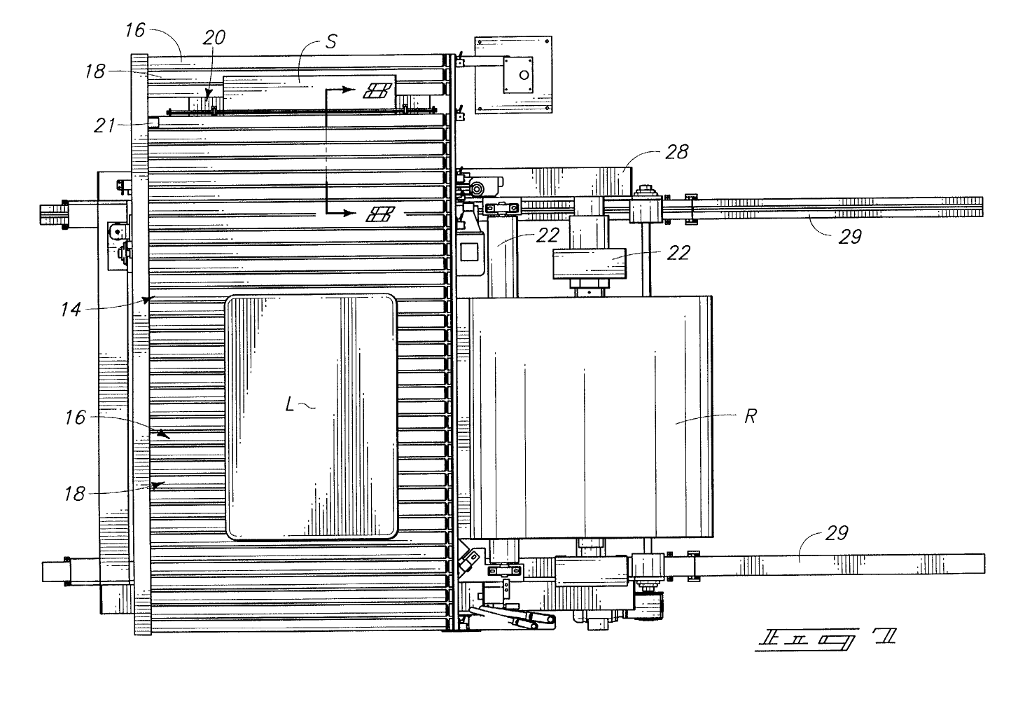

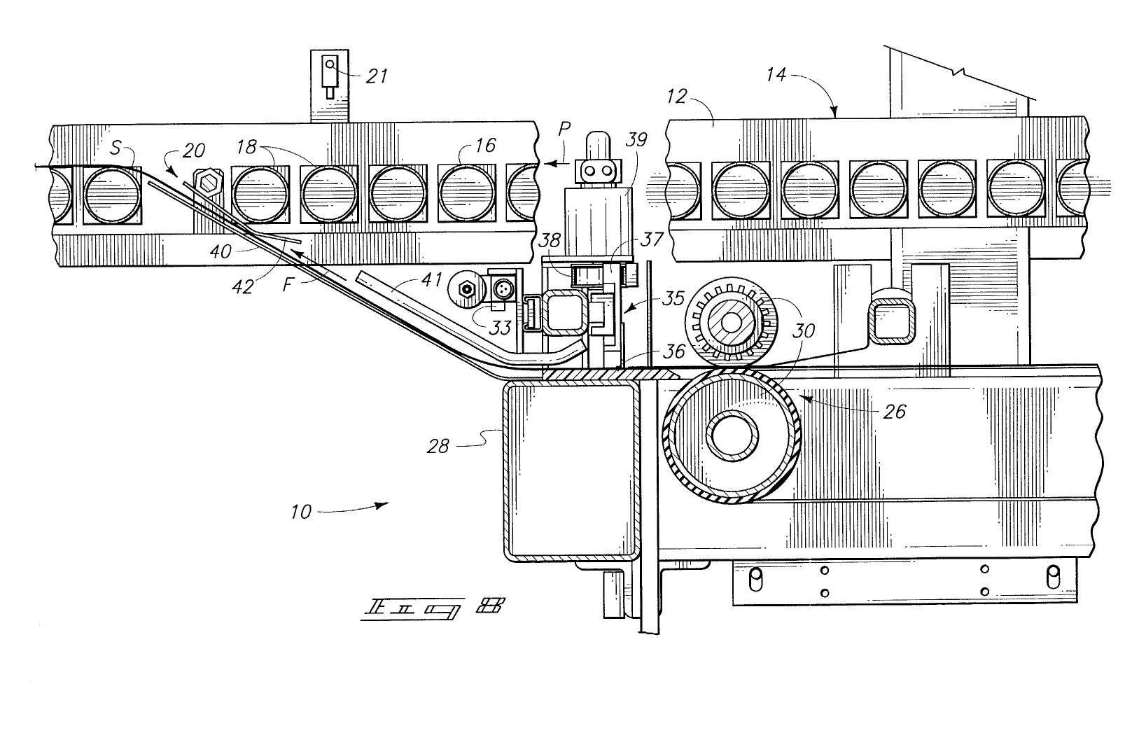

It is pointed out that the frame 28 preferably mounts the roll support 22, idler roll 23, mandril 25, bottom sheet feeder 26, and cutter 35; all in prescribed relation to one another and for motion in unison between the operative position shown in FIGS. 3 and 7, and the roll exchange position shown in FIGS. 4 and 6. Such mounting arrangements enable repair and maintenance of the bottom sheet inserter equipment without requiring dismantling of the adjacent conveyor 14; or significant interruption of conveyor operation. Further, this arrangement of elements facilitates initial setup of the sheet feed at the inoperative position, significantly simplifying the setup procedures.

Steps of operation for the bottom sheet inserter begin with placement of a roll R of the bottom sheet material S onto the roll supports 22. This is preferably done while the bottom sheet frame 28 is in the inoperative, roll exchange position shown in FIGS. 4 and 6. Once the roll R is mounted, the bottom sheet material is threaded under the idler roll 23 and along the initial feed path I to the mandril 25.

The free end of the sheet material S is inserted under the mandril 25, then over the top surface thereof to complete a bend in the sheet flow path from the initial flow direction I to the final bottom sheet flow direction F.

The free sheet end is next fed through the nip rolls 30. The bottom sheet frame 28 may now be moved manually or under power to the operative position (FIG. 3). The machine is now ready for operation.

During operation of the conveyor 14, a load L, which may comprise a stack of articles, will move along the working flight 16 in the forward direction P. As the load moves past the bottom sheet insertion station 20, an appropriate sensor 21 may be used to actuate the nip rolls 30 which are operated to feed the bottom sheet material S up between the conveyor rollers and into the path of the load.

The forwardly moving load L and forwardly moving bottom sheet S converge, with the bottom sheet S feeding automatically and without force underneath the load and along the working flight of the conveyor. The load is not disturbed by this activity since the bottom sheet motion is simultaneous with movement of the load in the forward direction and along substantially the same plane. The load need not be jostled or dropped onto the bottom sheet but flows evenly along with the sheet during the placement.

The bottom sheet S is fed along with movement of the load L until a trailing edge of the load moves past a selected point as determined by an appropriate sensor 21. At this point, the cutter 35 may be operated to cut the bottom sheet free, thereby leaving a single length of bottom sheet material under the load as graphically indicated in FIG. 2. The remainder of the bottom sheet material is poised adjacent the bottom sheet insertion station 20, ready for the next load.

It is pointed out that various switching and control systems may be utilized to automate the above operation. For example, at least one sensor 21 may be used along the conveyor 14 to control operation of the system to sense the approach of a load and initiate operation of the sheet feeder 26 and related components. Such controls and switching arrangements are well within the skill of the ordinary control designer and will not be discussed in further detail herein. It is also possible for the individual mechanisms to be operated by manual controls or by hand.

When the roll R becomes depleted, it may be preferable to manually cut the sheet material S in the vicinity of the roll, remove the empty roll, and replace the empty roll with a fresh roll. The free end of the fresh roll may then be attached by tape or another appropriate fastener to the cut end of the previous roll. The nip rolls 30 can now be used to thread the new roll through the idler 23 and mandril 25 without requiring re-threading of the sheet material through the nip rolls. Of course this operation is preferably accomplished with the bottom sheet frame 28 in the inoperative, roll exchange position.

In order to eliminate a need to provide specific feed drive for rotating the roll R, controls in addition to the generic switching and control arrangements may be provided to add functions to the drive 32 for the nip rolls. For example, a conventional sensor such as a photo eye 33 (positioned to detect the end of the cut bottom sheet) may be used to signal that the cut edge of the bottom sheet S has moved clear of the cutting area. In response, the nip roll drive 32 may be controlled to slowly decelerate to a stop. The deceleration rate may be set at a rate slightly slower than a coasting rate for the roll. This will allow the paper roll to come to a stop while the paper going through the nip roll remains tensioned, which will set the bottom sheet material in a preferred condition for the next cycle.

In addition to or as an alternative to the above, an appropriate conventional braking device 46 (FIG. 2 in schematic form) may be placed over the roll or more preferably in engagement with the axle or roll hub for the roll to create sufficient drag to maintain a desired amount of sheet tension and reduce the possibility that the roll could continue under momentum and produce undesired slack between the roll and nip rolls. The brake 46 (FIG. 2 in schematic form) may be wired or otherwise be controlled by sensing operation of the nip rolls 30 so that when the nip roll drive stops, the brake 46 will be applied. Conversely, when the nip rolls 30 are operating, the brake 46 will be released.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A roll feed bottom sheet inserter, comprising:
a conveyor frame;
a conveyor on the conveyor frame with a working flight defining a load support surface and a forward path of travel on the load support surface, the conveyor being operable to move a load along the path to a bottom sheet insertion station;
a bottom sheet roll support configured to rotatably mount a bottom sheet roll about a roll axis located adjacent to and extending along side the working flight to feed sheet material from the roll and toward the conveyor;
a training surface adjacent the roll support, oriented to receive a bottom sheet material from the bottom sheet roll and to angularly deflect the bottom sheet material to a bottom sheet feed path that converges with the load support surface from under the working flight; and
a bottom sheet feeder adjacent the bottom sheet insertion station and operable to receive the bottom sheet material from the training surface and feed the bottom sheet material through the bottom sheet insertion station and into the forward path of the load such that the bottom sheet material may be positioned on the conveyor between the load support surface and the load.

2. The bottom sheet inserter of claim 1, further comprising a cut-off blade movably positioned adjacent the bottom sheet insertion station.

3. The bottom sheet inserter of claim 1 wherein the cutter is comprised of a circular knife blade.

4. The bottom sheet inserter of claim 3 wherein the knife blade is mounted to a carriage for movement across the bottom sheet material at a location downstream of the bottom sheet feeder with respect to the forward path of travel.

5. The bottom sheet inserter of claim 1 wherein the bottom sheet roll support and training surface are mounted to a bottom sheet feeder frame independently of the conveyor frame.

6. The bottom sheet feeder of claim 1 wherein the bottom sheet roll support and training surface are mounted to a bottom sheet feeder frame independently of the conveyor frame, and further comprising a track mounting the bottom sheet feeder frame for movement toward and away from the conveyor frame.

7. The bottom sheet feeder of claim 1 wherein the training surface is comprised of a mandrel mounted to a bottom sheet feeder frame about a mandrel axis and wherein the mandrel is at least partially non-rotatable about the mandrel axis.

8. A roll feed bottom sheet inserter for placing bottom sheet material under a load moving along and supported by a working flight of a conveyor, comprising:
a bottom sheet roll support configured to be positioned to a side of the conveyor to mount a bottom sheet roll for rotation about a roll axis adjacent to the working flight, and to feed sheet material from the roll and toward the conveyor;
a training surface adjacent the roll support, oriented to receive bottom sheet material from the bottom sheet roll and to angularly deflect the bottom sheet material along a bottom sheet feed path; and
a bottom sheet feeder adjacent the bottom sheet insertion station and operable to receive the bottom sheet material from the training surface and adapted to feed the bottom sheet material into the forward path of the load on the conveyor such that the bottom sheet material is received between the load and the working flight.

9. The bottom sheet inserter of claim 8, further comprising a cut-off blade movably positioned adjacent the bottom sheet insertion station.

10. The bottom sheet inserter of claim 8 wherein the cut-off blade is a circular cutter mounted to a carriage for movement across the bottom sheet material.

11. The bottom sheet inserter of claim 8 wherein the training surface is comprised of a mandrel mounted to a bottom sheet feeder frame about a mandrel axis and wherein the mandrel is at least partially non-rotatable about the mandrel axis.

12. The bottom sheet inserter of claim 8 wherein the bottom sheet roll support, training surface and bottom sheet feeder are mounted to a bottom sheet feeder frame and wherein the bottom sheet feeder frame is movably mounted on tracks for movement toward and away from the conveyor.

13. The bottom sheet inserter of claim 12 further comprising a cut-off blade mounted to the bottom sheet feeder frame.

14. The bottom sheet inserter of claim 8 wherein the training surface is comprised of an elongated substantially cylindrical mandrel.

15. The bottom sheet inserter of claim 14 wherein the substantially cylindrical mandrel is formed along a mandrel axis and wherein the mandrel is at least partially non-rotatable about the mandrel axis.

16. A process for inserting a bottom sheet from a roll of bottom sheet material into position under a load on a conveyor and over a top support surface of the conveyor which defines a forward path of travel for the load, comprising:
mounting a bottom sheet roll for rotation about a roll axis located along side the conveyor support surface and forward path of travel;
feeding bottom sheet material from the roll along an initial feed path toward and under the conveyor support surface;
training the bottom sheet material over a mandrel to deflect the bottom sheet material angularly under the conveyor support surface and into a bottom sheet feed path that converges with the forward path and with a bottom sheet insertion station located along the conveyor support surface;
feeding the bottom sheet material through the bottom sheet insertion station;
moving the load in the forward path to intersect with the bottom sheet material at the bottom sheet insertion station; and
simultaneously moving the bottom sheet material and load in the forward path with the bottom sheet material feeding under the load and onto the conveyor support surface.

17. The process of claim 16, comprising the further step of cutting the bottom sheet material once a prescribed length of the bottom sheet material is moved onto the conveyor support surface.

18. The process of claim 16 wherein the step of training the bottom sheet material is accomplished by bending the bottom sheet material over an angular mandrel under the conveyor support surface.

19. The process of claim 16 wherein the step of training the bottom sheet material is accomplished by bending the bottom sheet material over a mandrel mounted to a bottom sheet feeder frame about a mandrel axis; and
wherein the mandrel is at least partially non-rotatable about the mandrel axis.

20. The process of claim 19 wherein the stop of training the bottom sheet material is accomplished by bending the bottom sheet material over an angular mandrel under the conveyor support surface; and further including the steps of directing the bottom sheet material to a nip roll under the conveyor support surface upstream of the bottom sheet insertion station; and cutting the bottom sheet material at a location downstream of the nip roll and under the conveyor support surface once a prescribed length of the bottom sheet material is moved onto the conveyor support surface.

21. The process of claim 16 comprising the further step of pulling the bottom sheet material across the mandrel using powered nip rolls situated downstream of the mandrel and upstream of the bottom sheet insert station.

22. The process of claim 16 including the further step of mounting the roll and mandrel to a bottom sheet frame and movably supporting the bottom sheet frame for movement away from the conveyor support surface to a roll exchange station.

23. A process for adapting a load moving conveyor to insert bottom sheet material from a roll of bottom sheet material into position under a working flight of the conveyor that defines a forward path of travel for the load, comprising:
providing a bottom sheet frame
mounting a bottom sheet roll to the bottom sheet frame for rotation about a roll axis;
feeding bottom sheet material from the roll along an initial feed path from the roll to a mandrel;
training the bottom sheet material over the mandrel to deflect the bottom sheet material angularly from the initial feed path and into a bottom sheet feed path;
gripping the bottom sheet material between powered nip rolls that are operable to pull the bottom sheet material from the roll and over the mandrel, and to feed the bottom sheet material along a bottom sheet material feed path;
providing a bottom sheet insertion station along the conveyor;
positioning the mandrel and powered nip rolls beneath the conveyor support surface such that the bottom sheet material feed path converges with the bottom sheet insertion station located along the conveyor support surface; and
driving the nip rolls to feed the bottom sheet material through the bottom sheet insertion station.

24. The process of claim 23 comprising the step of movably mounting the bottom sheet frame to facilitate movement toward and away from the conveyor.
